(19) United States
(12) Patent Application Publication
(10) Pub. No.: US 2009/0055369 A1
(43) Pub. Date: Feb. 26, 2009

(54) SYSTEM, METHOD AND APPARATUS FOR IMPLEMENTING DYNAMIC COMMUNITY FORMATION PROCESSES WITHIN AN ONLINE CONTEXT-DRIVEN INTERACTIVE SOCIAL NETWORK

(76) Inventors: Jonathan Phillips, Golden, CO (US); Peter Newcomb, Erie, CO (US); Robert Reich, Boulder, CO (US); Bob Gilson, Lyons, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/024,984

(22) Filed: Feb. 1, 2008

Related U.S. Application Data
(60) Provisional application No. 60/887,691, filed on Feb. 1, 2007.

(51) Int. Cl. G06F 7/06; G06F 17/30

(52) U.S. Cl. 707/4; 707/E17.108

(57) ABSTRACT

A method for showing a user navigating to a first website a collection of other websites relating to the first website comprising: identifying a first, second and third user having navigated to the first website; collecting navigation history tails from the first, second and third users, the navigation history tails identify websites navigated to by the first, second and third users, the navigation history tails further have an identification of each of the users; combining the navigation history tails to form a cumulative navigation history tail; generating a rank of some of the websites identified in the cumulative navigation history tail, the rank indicating a popularity of some of the websites identified in the cumulative navigation history tail; and providing the rank to an applet so the applet can generate an indication of websites based on the rank.

### PRIORITY

The present application claims priority to commonly owned and assigned provisional application No. 60/887,691, filed Feb. 1, 2007, Attorney Docket No. MEDM-002/00US, entitled SYSTEM, METHOD AND APPARATUS FOR IMPLEMENTING DYNAMIC COMMUNITY FORMATION PROCESSES WITHIN AN ONLINE CONTEXT-DRIVEN INTERACTIVE SOCIAL NETWORK which is hereby incorporated by reference in its entirety.

### RELATED APPLICATIONS

The present application is related to commonly owned and assigned application Ser. No. 11/556,655, filed Nov. 3, 2006, which is hereby incorporated by reference in its entirety.

### FIELD OF THE INVENTION

The present invention relates generally to systems and methods for providing and managing on-line user communities and social networks, and more particularly to a system and method for improving the advantageous functionality based on data explicitly and/or implicitly derived from routine utilization of the communities by their users.

### BACKGROUND OF THE INVENTION

Attempts have been made for forming an online community where users could interact with one another. Many such attempts include external add-ons to an online community wherein the add-ons functioned separately from the community. When functions were integrated into a community system, they did not provide sophisticated features. Users were often required to expend significant effort to seek out and identify relevant content as well as other users with similar interests.

It is desirable to provide systems and methods for customizing the online community experience and functionality based on context relevant to a user's current activities. It is further desirable to provide a system and method for implementing dynamic community formation processes that improve the scope, quality, and relevance of dynamically formed contextual communities based on data derived from routine utilization of the system by the users without requiring additional efforts from the users. These issues are addressed herein.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the particular forms described in this Summary of the Invention or in the Detailed Description. One skilled in the art can recognize that there are numerous modifications, equivalents and alternative constructions that fall within the spirit and scope of the invention as expressed in the claims.

A system and method for showing a user that navigates to a first website a collection of other websites that relate to the first website is described. In one embodiment, the method includes the steps comprising: identifying a first user having navigated to the first website; identifying a second user having navigated to the first website; identifying a third user having navigated to the first website; collecting a first navigation history tail from the first user, the first navigation history tail identifying websites navigated to by the first user, the first navigation history tail further having an identification of the first user; collecting a second navigation history tail from the second user, the second navigation history tail identifying websites navigated to by the second user, the second navigation history tail further having an identification of the second user; collecting a third navigation history tail from the third user, the third navigation history tail identifying websites navigated to by the third user, the third navigation history tail further having an identification of the third user; combining the first navigation history tail with the second navigation history tail to form a first cumulative navigation history tail; combining the third navigation history tail with the cumulative navigation history tail to form a second cumulative navigation history tail; generating a rank of some of the websites identified in the second cumulative navigation history tail, the rank indicating a popularity of some of the websites identified in the second cumulative navigation history tail; and providing the rank to an applet so the applet can generate an indication of websites based on the rank.

### BRIEF DESCRIPTION OF THE DRAWINGS

In the drawings, wherein like reference characters denote elements throughout the several views:

FIG. 1 illustrates one embodiment of an architecture on which the present invention may be utilized;

FIG. 2 illustrates another architecture for implementing certain embodiments of the present invention;

FIG. 3 is a flow diagram illustrating a method for generating an invitation from one user to another;

FIG. 4 is a flow diagram illustrating a method of inviting members to become friends based on similar interests;

FIG. 5 is a screen shot of a graphical interface used to visually display information about the community;

FIG. 6 is another screen shot of a graphical interface used to visually display information about the community;

FIG. 7 is another screen shot of a graphical interface used to visually display information about the community;

FIG. 8 is a flow diagram illustrating a method for displaying information about friends associated with a member;

FIG. 9 is a flow diagram illustrating a method for capturing information associated with a chat message between members;

FIG. 10 is a diagram illustrating information relevant to activities within the community;

FIG. 11 is a diagram illustrating additional functionality permitted by a member while browsing within the online community;

FIG. 12 is a flow diagram illustrating the steps for displaying data about each member currently viewing a website where a community widget is located;

FIG. 13 is a flow diagram illustrating the steps for dynamically displaying a widget within a web page;

FIG. 14 is a screenshot of a web page illustrating a community widget embedded into a web page;

FIG. 15 is a flow diagram illustrating how a neighborhood widget's content may change over time.

FIG. 16 is a screenshot of a web page illustrating an inline view widget embedded into a hyperlink on a web page;

FIG. 17 is a flow diagram illustrating the steps for displaying a pop-up representing an inline view widget;

FIG. 18 is a flow diagram illustrating the steps to initiate a search within the community;

FIG. 19 is a flow diagram illustrating the steps that can be taken when a result set is returned to a member;

FIG. 20 illustrates another embodiment of an architecture on which the present invention may be utilized; and

FIG. 21 is a flow diagram illustrating the steps for recommending contextually relevant advertising to a member.

### DETAILED DESCRIPTION OF PREFERRED EMBODIMENTS

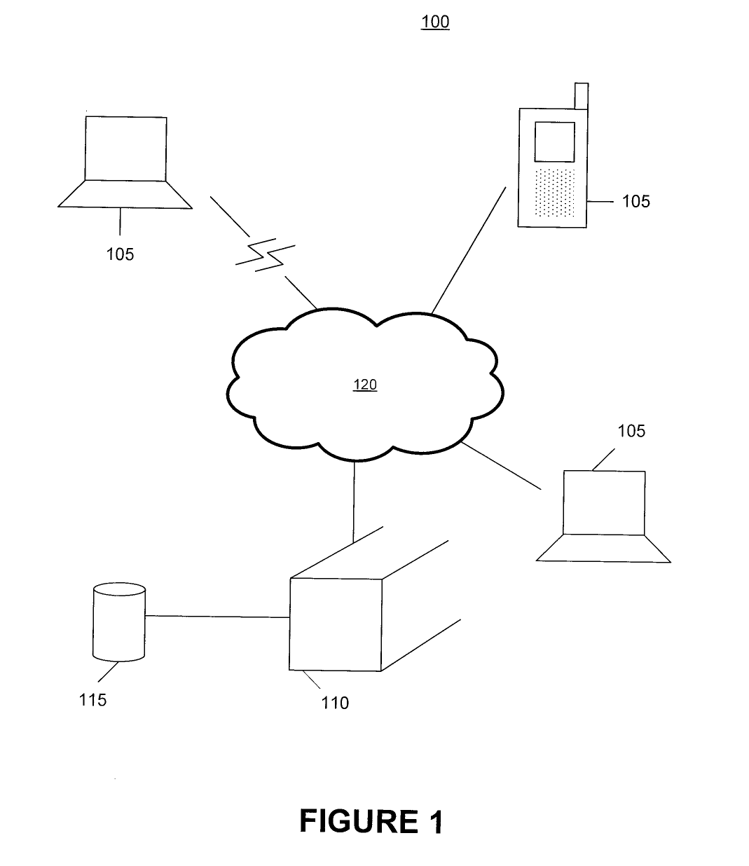

Referring now to the drawings, where like or similar elements are designated with identical reference numerals throughout the several views, and referring in particular to FIG. 1, it illustrates an exemplary architecture 100 on which embodiments of the present invention could be utilized. This embodiment includes users 105, also referred to as “actors,” connected to a server 110 and database 115 through a network 120. In certain instances, the term “actors” includes human users, software, or some combination of the two. The server 110 and database 115 generally contain software for collecting information regarding actors' actions and for generating recommendations. The term “action” refers to act(s) performed by actors, act(s) in combination with resources, resource(s), resource(s) in combination with implied acts, and act(s) in combination with implied resources. This software or software-hardware combination is sometimes referred to as the “recommendation engine.” The recommendation engine could be operated on a personal computer or a larger computer system. The actors could use a typical personal computer, a computer terminal, or a mobile device (such as a cell phone or PDA) to access the server and associated database. The network that connects the users to the recommendation generator could be the internet, an intranet, a corporate LAN, or any other type of network.

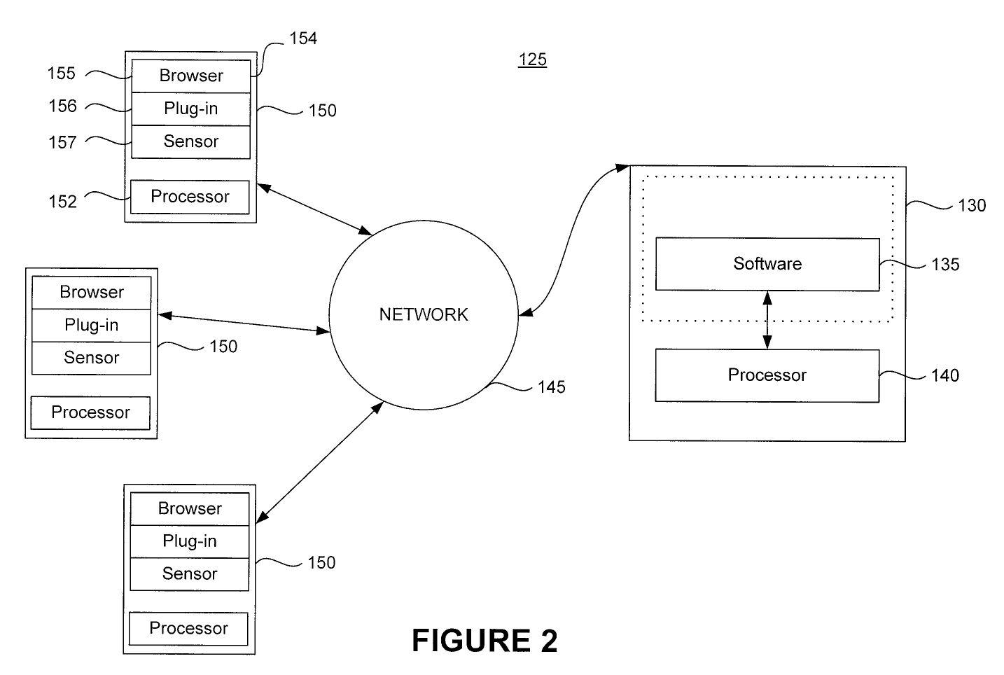

Referring now to FIG. 2, it illustrates a differing architecture 125 for implementing certain embodiments of the present invention. In this implementation, the server 130 includes recommendation software 135 executing on a processor 140. The server is connected, through a network 145, to three actors 150. Each of these actors 150 is operating a computing device that includes a processor 152 executing software 154. This software 154 may include a browser 155, a plug-in 156 for extracting information about the actor's actions and sending it to the recommendation software and a sensor 157 for monitoring the actor's actions. The actor's system could include chat programs, instant messaging programs, email programs, word processing programs, and similar programs. The plug-in 156 may collect information about the actor's actions. Other embodiments do not necessary include a plug-in. For example, the actor could be interacting with an Active Server Page (“ASP”), and the ASP would collect the relevant information.

In another embodiment, the components of the software 154 for each actor 150, may differ. For example, the software 154 may include the browser 155, an Internet resource (not shown) loaded in the browser 154 and plug-in code 157 within the browser page for extracting and displaying information from the server based on the browser page's encoded parameters.

Creation of a Friend Invitation in a Dynamically Formed Contextual Community

One advantage of a dynamically formed contextual community is the concept of “friends.” Friends may be other online users having been associated with each other in some manner. Friends may be associated with one another based on an actual friendship outside the online community. In an example, friend A may have manually invited friend B to associate with friend A in an online community. Upon acceptance of the invitation friend B may be associated with friend A. In yet another example, user A and user B may not know each other in any capacity within or outside the online community. However, based on similar interests within the online community, an invitation may be sent to user A and user B. Such an invitation may suggest that user A and user B become online friends. Upon acceptance of the invitations from both users, user A and user B may now become friend C and friend D.

In other words, new system users may become friends with the people who invited them to the social network community or through automated invitations from the community itself. This assists in further community formation and provides a simple way for a user to befriend the person who originally invited the user to the online community.

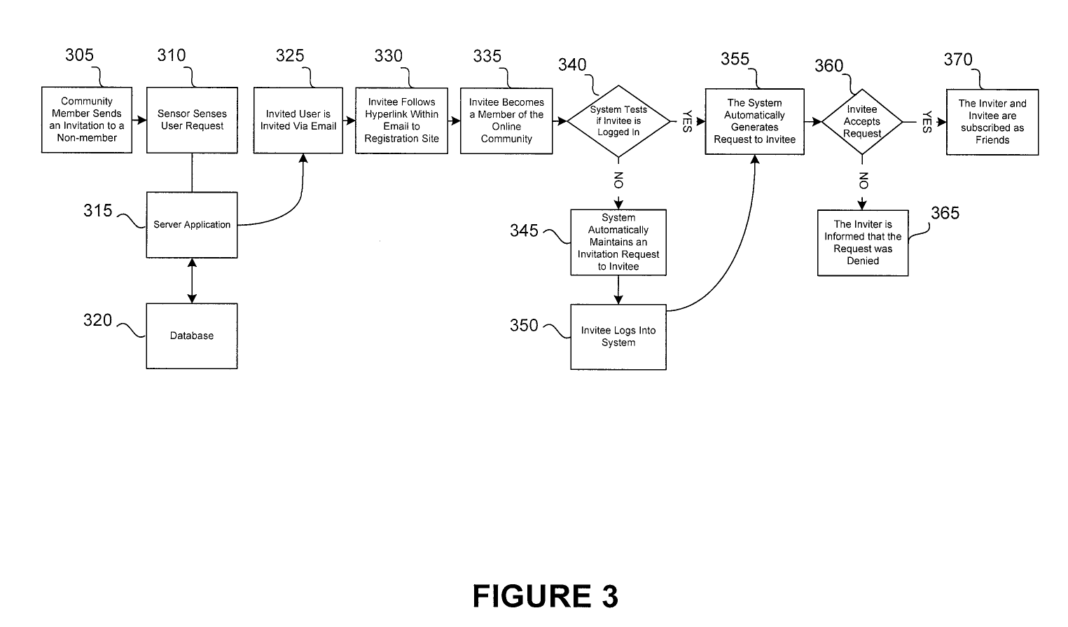

FIG. 3 is a flow diagram illustrating a method for generating an invitation from a community member to a user. The term “community member” may be defined as a user having previously registered with an online community. In one embodiment, the system that generates such a request is known as an auto-friending system. The auto-friending system may monitor the members of the online community. An existing community member sends a “friend invitation” to a non-member of the community (step 305). The sensor 157 associated with the member senses the invitation request (step 310) and transmits the request to the server 130 hosting the auto-friending system (step 315). Upon receipt of the request, the server 130 queries the database 115 and retrieves relevant information from the member (step 320). Next, the server 130 sends an invitation to join the online community to the non-member (step 325). In one embodiment, the request is sent via email to the email address associated with the invitation request.

Upon receipt of the invitation, the non-member may follow the hyperlink contained within the email (step 330). This hyperlink contains a link to a registration website associated with the online community. Once the non-member registers with the online community, they become a member of the community (step 335). Once, the non-member becomes a member (“new member”) the auto-friending system detects when the new user initially logs into the community (step 340). Until the new member logs in, the auto-friending system maintains the friend request from the original member (step 345). In one embodiment, the new member is stored as a pending friend in a friend list of the original member. Once the new member logs into the community (step 350), the auto-friending system generates the friend invitation and transmits the invitation to the new member (step 355). Next, the new member has the choice to accept or reject the friend invitation (step 360). If the new member does not accept the friend invitation, the original member is informed that the invitation was rejected (step 365). On the other hand, if the invitation is accepted, the original member and the new member are joined as friends (step 370) within the online community. Further, the original member's friend list is updated to show the new member as a friend and no longer a pending friend.

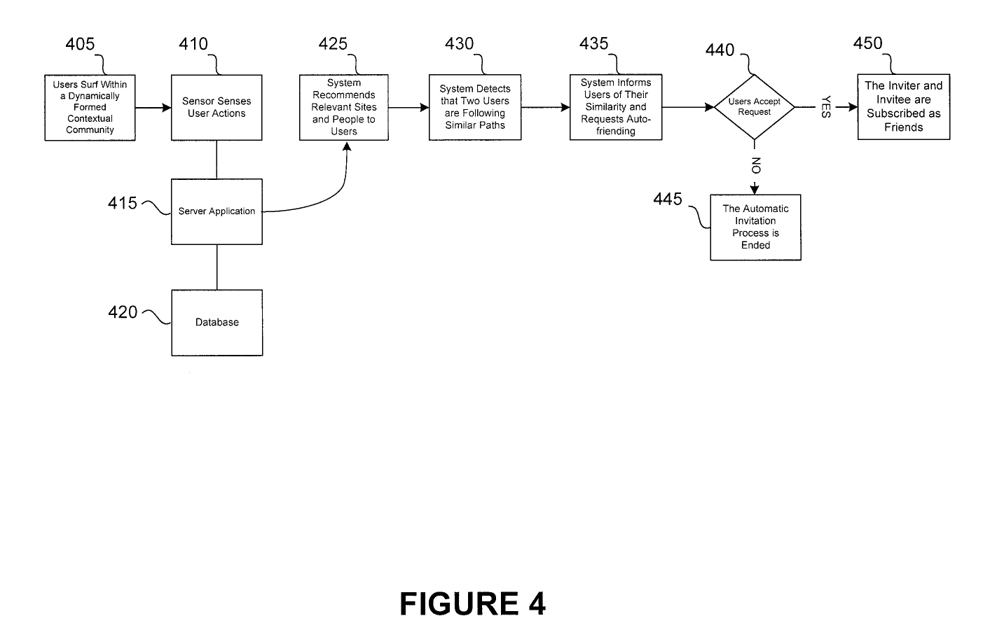

FIG. 4 is a flow diagram illustrating a method of inviting members to become friends based on similar interests. The dynamically-formed contextual community, as described above, may be aware of which members have relevant interests to each other as they surf the Internet. Upon detecting two members who are not currently friends, the auto-friending system may automatically proffer invitations to both users recommending they become friends.

Member A and member B surf the Internet (step 405). The browsing history of each member is sensed by the sensor 157 of each members client software 154 (step 410). This information is dynamically transmitted to the server 130 associated with the auto-friending system (step 415) and stored in the database 115 (step 420). The auto-friending system may analyze the browsing history of member A and member B and recommend relevant websites and other members (step 425). Further, the auto-friending system may detect that member A and member B has similar browsing histories (step 430). The auto-friending system may inform member A and member B that they have similar interests and recommend they become friends (step 435) by transmitting an invitation to each of the members. As described in FIG. 3, each invitation is stored until each member logs in, views the invitation and decides if they wish to accept the invitation (step 440). If one or both of the members reject the invitation, the invitation process ends (step 445). However, if both member A and member B accept the invitation, both members become associated as friends (step 450).

### Interactive Preview of Relevant Information

It is desirable to enable community members to gain further insight into and interact with the elements presented by the dynamically-formed community. Examples include other members, friends, chat messages or other resources. In one embodiment, such information may be used to gain insight into these elements or decide to interact with them without having to explicitly abandon their current activities (e.g., current website they are browsing.) There are several approaches to providing this information to members within the dynamically formed community.

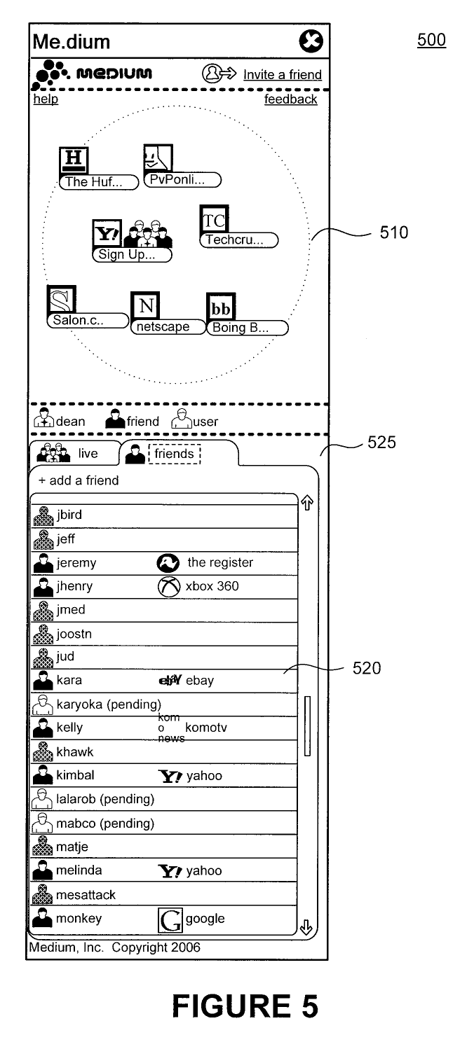

FIG. 5 is a screen shot of a graphical interface used to visually display information about the community. In one embodiment, the graphical interface is a browser plug-in 500 associated with a web browser. Members of the online community may wish to gain further information about their friends within the community. For example, a member may gain further information about their friend's activities in the community by observing the current online location of each of their friends. A community map 510 may iconically illustrate a list of recommended websites along with the member's friends who are currently viewing the recommended websites. In one embodiment, both members who are friends and non-friends may be visually illustrated in the community map 510. Differing visual representations, such as color, may be used to differentiate a friend from a non-friend. In another embodiment, the current location of each member may dynamically change as the actual member changes their browsing location. For example, friend A may be graphically represented as visiting Netscape.com™. If the member redirects their browser to Google.com™, the graphical representation of the member may be seen moving from the icon representing Netscape.com to the icon representing Google.com. Such a system permits a member from dynamically seeing the location of each friend and non-friend as they browse the Internet.

The plug-in may also contain a friend panel 520 which may list the names of each friend associated with the member in the friend list tab 525. In one embodiment, the friend list tab 525 may further list (textually and iconically) the current website location of each friend (if they are currently online), whether each friend is online or not, and whether the friend is an actual friend or pending as a friend. For example, the friend named “jhenry” is seen as online and current browsing the website xbox360.com™. Similarly, the friend named “jeff” is currently offline. Lastly, the friend named “karyoka” is listed as a pending friend. Hence, karyoka has received an invitation from the member to become a friend, but they have not yet accepted or rejected the invitation.

In another embodiment, each friend listed in the friend list tab 525 may have information about them stored as a public profile. The member may be able to move over other friends within the community environment and receive information related to the current page that individual is browsing, their public profile and the relevant historical pages that individual has broswed. For example, the member may move over jhenry. Any public information about jhenry may be displayed in a pop-up window. Such information may include, date of birth, real name, contact info, interests, a photo of the friend, etc. Any member may include different amounts of information available to both friends and the public in general (e.g., non-friend members of the community). Further, the pop-up window may display the specific web page jhenry is browsing as well as historically relevant browsing history of jhenry.

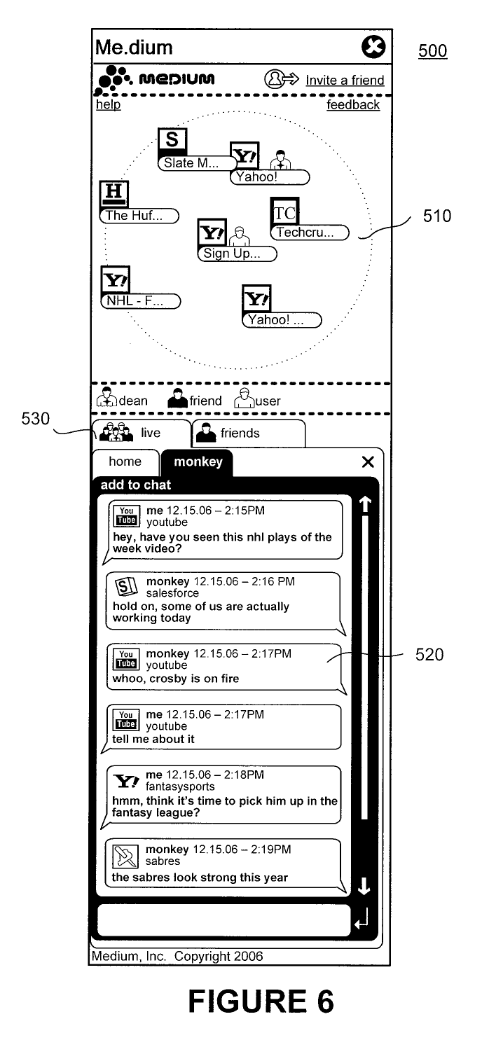

FIG. 6 is another screen shot of the graphical interface used to visually display information about the community. In this embodiment, the friend panel 520 has an additional tab called the chat tab 530. The chat tab 530 may display a chat message stream between the member and the friends associated with the member. For example, a chat message stream may textually display communication between the member (“me”) and a friend named “monkey.” In one embodiment, the chat message streams between the member and each friend may be independently represented in individual tabs. Each chat tab may be titled by the name of the friend for which the chat message stream is associated with. Multiple chat tabs may exist for each friend the member is having a textual conversation. In another embodiment, the member and multiple friends may chat together in another chat tab.

In regards to FIG. 5 and FIG. 6, it may also be possible for the member to join a friend by clicking on the graphical representation of the friend's location to join that friend at their location on the Internet. In the case of chat messages, the context provided by this additional information may allow the member and/or friend to indirectly refer to the website they are both browsing. For example, chat phrases such as “Check this out” or “I'm over here” may be used where “this” and “here” may be interpreted by the chat message receiver as the website the chat message sender is visiting. This permits the chat message sender to avoid explicit language about the website they are browsing since the message sender and message receiver are both browsing the same website.

Additionally, the message receiver may value seeing context of a chat message or a friend's location even if the message sender does not indirectly refer to the context. Finally, the receiver may also value the ability to review the history of the chat seeing with each message the path the sender or senders have traveled browsing from site to site while chatting.

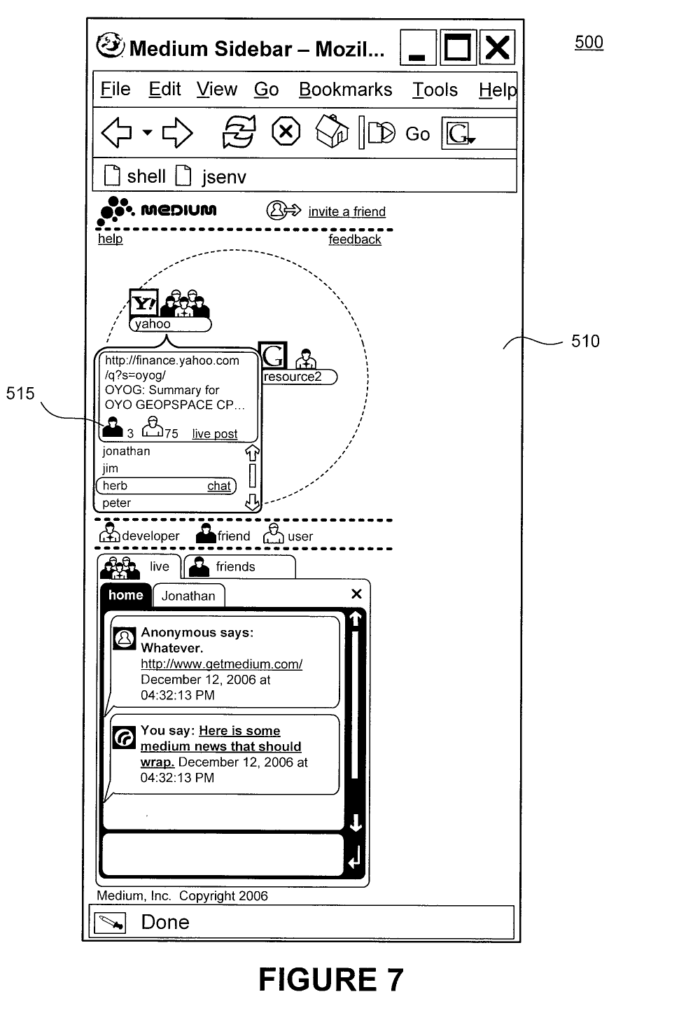

As described in FIG. 7, it is advantageous for members to learn valuable information about Internet sites that are contextually relevant to the Internet site they are currently browsing without having to abandon their current Internet location. FIG. 7 is another screenshot of the graphical interface used to visually display information about the community. As previously described, the community map 510 may iconically represent relevant websites and the members who are currently browsing these websites. In one embodiment, the member may move over an icon, permitting a pop-up window 515 to appear. In one embodiment, the pop-up window 515 may textually describe the specific website represented by the icon, as well as the members who are currently browsing the website.

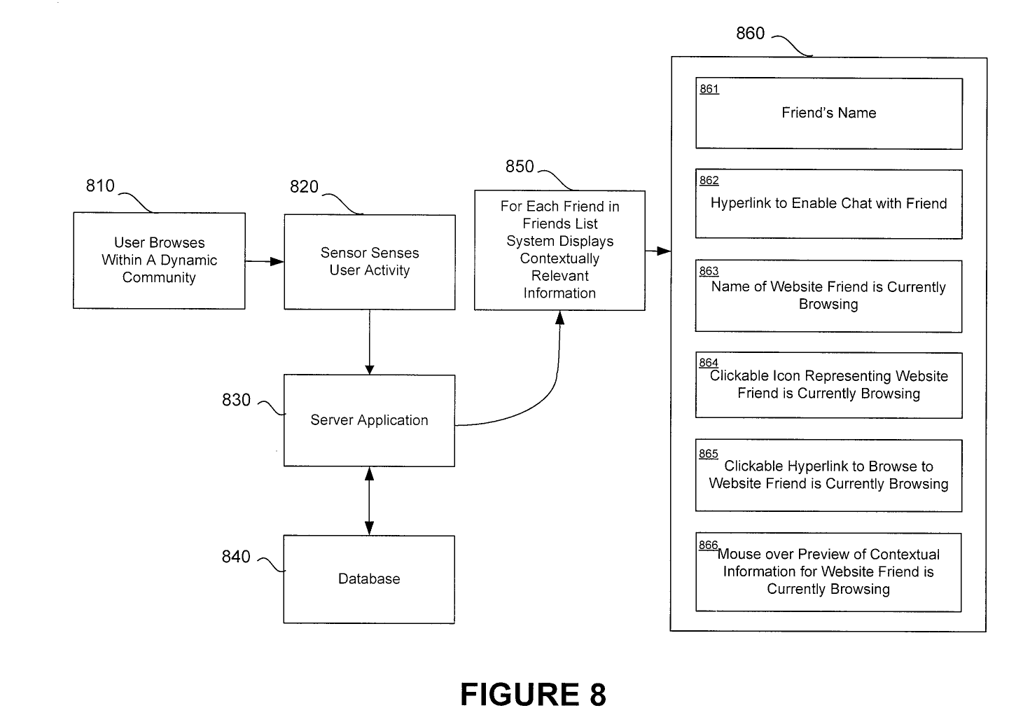

FIG. 8 is a flow diagram illustrating a method for displaying information about friends associated with a member. While a member associated with the online community browses the Internet (step 810), the sensor 157 associated with the member's browser software 154 senses the member's activity (step 820). The member activity is transmitted to the server 130 associated with the online community (step 830) and the activity information is stored in the database 115 (step 840). As the member continues to browse within the online community, contextually relevant information 860 about each friend of the member is generated (step 850). In one embodiment, the contextually relevant information 860 about each friend may include the following information: the friend's name 861; a hyperlink 862 to enable chat messaging with the friend; the name of the website 863 the friend is currently browsing; an interactive icon 864 representing the website the friend is currently browsing; a hyperlink 865 to browse the website the friend is currently browsing; and a move over hyperlink preview 866 of the contextual information for the website the friend is currently browsing. Those skilled in the art will realize that more or less information may be included in the contextual relevant information 860 without limiting the scope of the present invention.

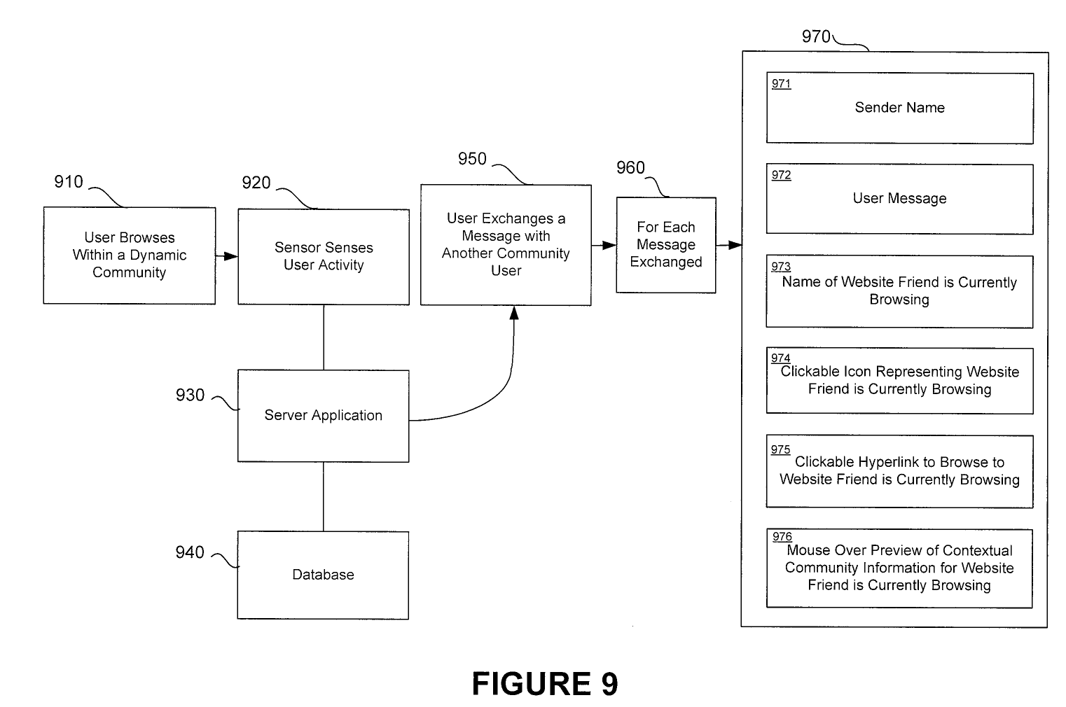

FIG. 9 is a flow diagram illustrating a method for capturing information associated with a chat message between members. While a member associated with the online community browses the Internet (step 910), the sensor 157 associated with the member's browser software 154 senses the member's activity (step 920). The member activity is transmitted to the server 130 associated with the online community (step 930) and the activity information is stored in the database 115 (step 940). The member may exchange chat messages with another member of the online community (step 950). For each chat message exchanged (step 960), contextually relevant information about each chat message may be generated (step 970). In one embodiment, the information about each chat message may include the following information: the message sender's name 971; the text of the message 972; the name of the website the sender's friend is currently browsing 973; an interactive icon 974 representing the website the sender's friend is currently browsing; a hyperlink 975 to browse the website the sender's friend is currently browsing; and a move over hyperlink preview 976 of the contextual information for the website the sender's friend is currently browsing. Those skilled in the art will realize that more or less information may be included in the contextual relevant information 970 without limiting the scope of the present invention.

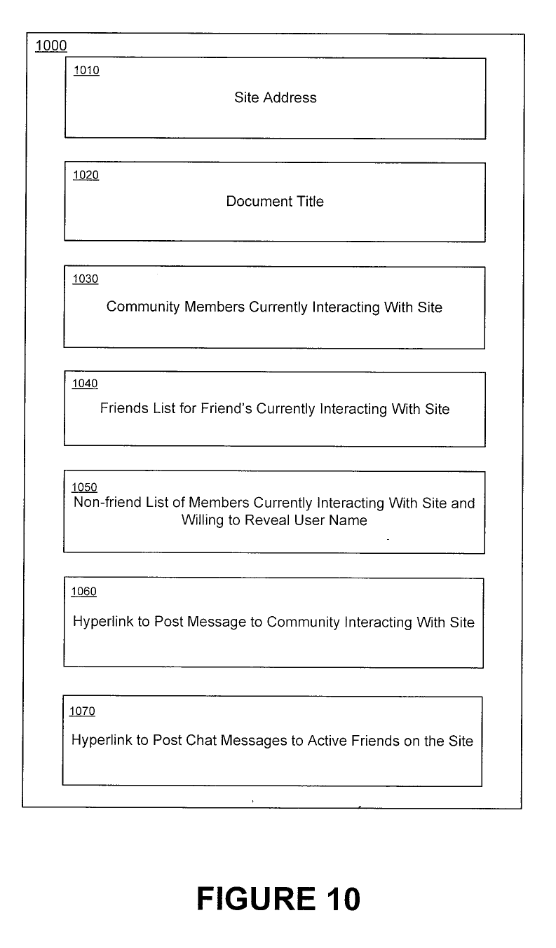

FIG. 10 is a diagram illustrating another embodiment of information relevant to activities within the community. In another embodiment, additional information for each website viewed by a member of the online community may be generated and stored in the database 115. This information may be displayed in the form of a pop-up window 1000 whenever a member moves their mouse over the iconic representation of a website. This information may include: URL information or the website address 1010; the title of the web page 1020; the number of other members currently visiting the URL 1030; the names of members visiting the URLs that are considered friends 1040; the names of other members who are browsing the URL but are not considered friends yet willing to reveal their user name 1050; a hyperlink to post chat messages to members who are currently browsing the URL; and a hyperlink to post chat messages to friends who are currently browsing the URL.

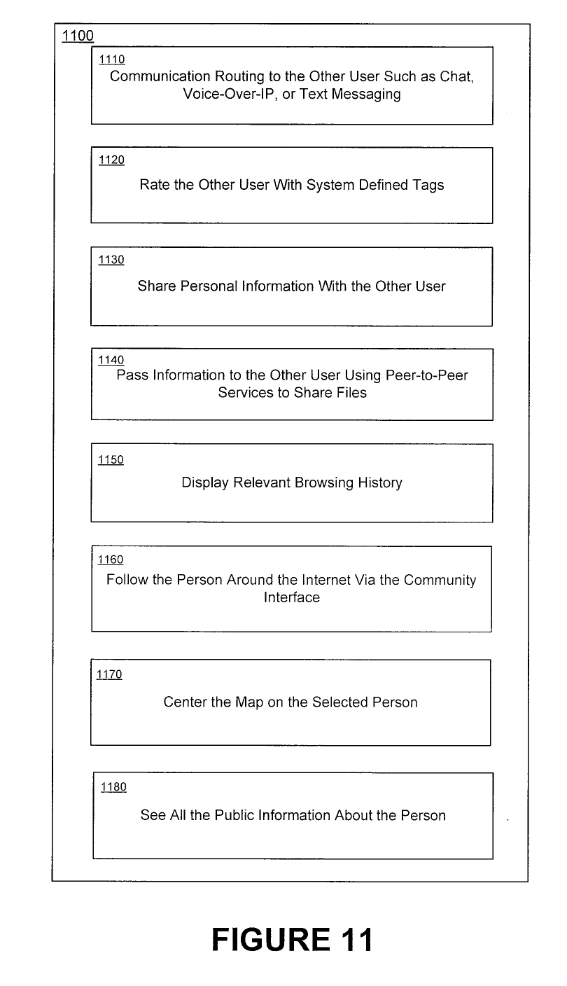

FIG. 11 is a diagram illustrating additional functionality 1100 available to a member while browsing within the online community.
Talk: Providing the member with a form of communication routing to a selected member 1110. Such forms of communication may include chat messaging, Voice-Over-IP (“VOIP”), or text messaging.
Tag: Providing the member the ability to create public or private information about another member 1120 such as ranking or other commentary.
Connect: Providing the member the ability to share personal information with another member 1130. In one embodiment, this information may be displayed through a pop-up window.
Share: Providing the member the ability to pass information back and forth to other members 1140 via peer-to-peer type services such as File Sharing.
History: Providing the member ability to display related websites visited by the member 1150.
Chase: Permitting other members the ability to follow another member around the Internet via a community interface 1160.
Center on: Permitting a member to center the community map over another member 1170 permitting the member to guide the other member through the Internet.
Profile: Permitting other members to see all of the public information made available by a member.

### An External View of the Online Community

As described above, a browser plug-in may be used to permit community members to see a visual representation of the community members associated with websites considered relevant. In one embodiment, this visual representation may exist in the sidebar of the browser. Hence, such a view is community-centric in nature. However, in another embodiment it is desirable to allow both members and non-members of the community to have an external view of other community members and their current location. This permits other users to graphically see where other people are browsing in near real-time. In such an embodiment, individual websites may add a community widget or applet onto their website. The terms widget and applet may be used interchangeable and refer to a block of computing code defining an application that runs inside a container application such as a web browser or a virtual machine (“VM”).

In another embodiment, the physical size of a community widget, as displayed on a web page, may vary. When a widget is defined by a user, physical dimensions may be input. These dimensions may be based on the number of pixels defining the bounds of widget. The dimensions of the widget may also be used to indicate the number of websites to be indicated. In one example, the smallest sized widget may indicate 4 websites. Whereas the largest sized widget may indicate 10 websites

There may be differing types of community widgets including but not limited to map widgets, neighborhood widgets, custom view widgets and inline view widgets. Each widget type will be explained in further detail below. However, a brief summary of each is described in the next paragraphs.

A map widget displays a focal point website, a collection of related websites and the community members who are currently residing on those websites. The focal website may be defined as the website where the widget is located. The relevant websites are websites where community members have visited either before or after having visited the focal website. In other words, the map widget displays where members, that have visited the focal website, have also visited. Thus providing recommendations to others with similar interests where else they may visit. One typical feature of each widget type is the visual representation of one or more community members and/or their current Internet location. As with plug-ins that visually represent community members, the widgets may provide similar functionality without a plug-in installed and enabled within the browser.

A neighborhood widget provides similar information as the map widget. However neighborhood widget does not have a focal website, but rather focuses on a content type. An example neighborhood widget may display a list of websites that relate to sports, music, news, games or other types of online content. Hence, a user interested in a specific content type may receive information of other websites that may be interesting to the user.

A custom view widget is a widget displaying a collection of websites along with other community members that are currently visiting those websites. The creator of the widget may select the specific websites to be included in the widget, thus giving others a snap shot view of predefined websites and how many community members are visiting them.

The inline view widget is similar to the map widget in that it displays a focal website, a collection of relevant websites and community members visiting those websites. A difference being that the inline view widget is embedded into a hyperlink to a different web page. In other words, the focal website displayed by the inline view widget is based on the underlying website the hyperlink points to and not the website the user is currently visiting. Such a widget permits a user to see website and community member activity of a different location, without having to navigate to the location.

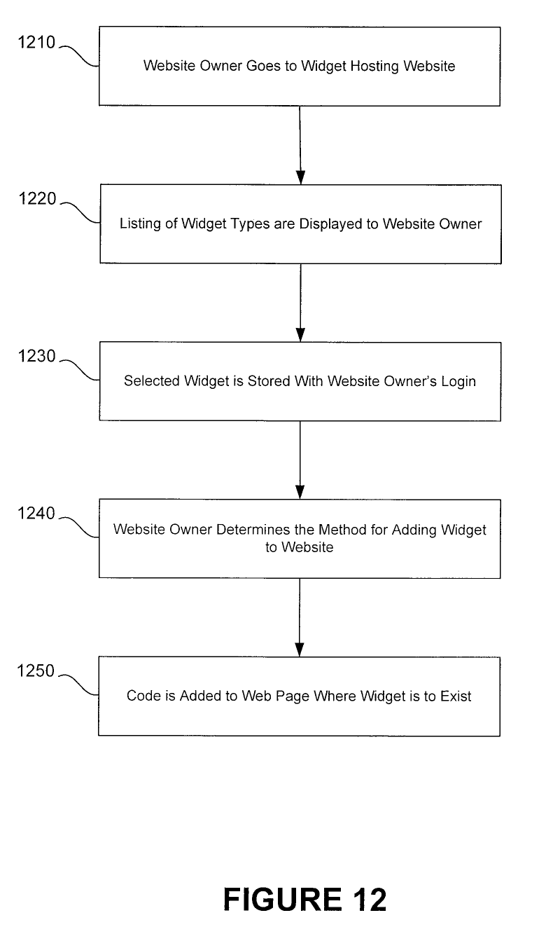

FIG. 12 is a flow diagram illustrating the steps for creating and placing a community widget onto a website. A website owner navigates to a website associated with the online community (“widget website”) where community widgets may be created (step 1210). In one embodiment, the owner may create a login with the widget website. Next, the owner may select from a list of pre-defined community widgets or create a custom widget (step 1220). Once the preferred community widget is selected or customized, the definition of the widget may be stored under the owner's login within the widget website (step 1230). Next, the owner may choose a method for placing embedding code, corresponding to the widget, onto their website in order to invoke the widget (step 1240). In one embodiment, Javascript code may be used to point to a specific location where the widget resides. For example, the code may be <script src=“http://www.me.dium.com/mapwidget/4096/0” type=“text/javascript”></script>. Hence, the owner may embed this code segment into the specific web page and location of its website where he would like the widget to appear. In another embodiment, a hyperlink on the widget website may permit automatic insertion of the widget code into an owner's website by clicking a button associated with the website the widget should appear. Lastly, the owner may manually or automatically embed the widget onto the desired website page and the page's physical location (step 1250).

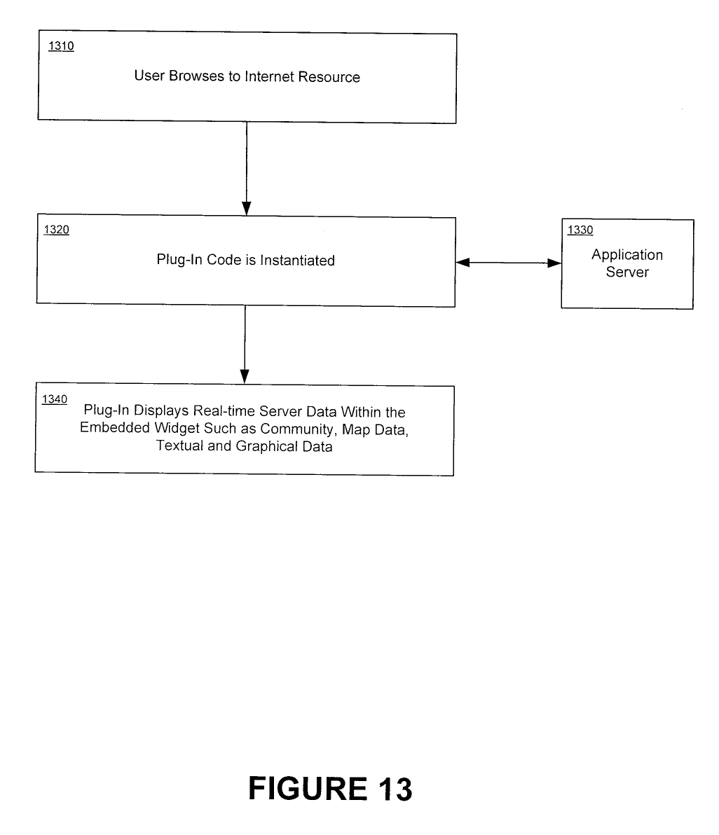

FIG. 13 is a flow diagram illustrating the steps for dynamically displaying a widget within a web page. Once a website owner has created and inserted a reference to a widget in their website, a back-end server application may be used to dynamically represent the content associated with the widget. Once a user browses to a web page where a widget is located (step 1310), software code associated with the widget is instantiated (e.g., an instance of the object representing the widget is created) (step 1320). In order to create the widget object, communication with the application server hosting the widget occurs (step 1230). In one embodiment, this communication includes a request to the application server 130 to create an instance of the widget object, followed by the instance of the widget object being provided by the application server 130. Once the instance of the widget is generated and appears on the web page, the widget displays near real-time server information (step 1340) corresponding to a collection of websites and the community members who are currently visiting those websites. This information may be periodically updated with new information as the underlying community members indicated on the widget navigate to different websites. In one embodiment, the previous navigation browsing history of each community member is provided to the application server 130 through a plug-in residing on each member's computer. With this information, the application server 130 is able to provide updated location information to the widget.

In another embodiment, widgets may be read-only or read-write. For example, the owner of a news weblog may select to embed a read-only version of a community widget within their website. The widget may use the website location as the focal point. Such a widget may display websites where other members have visited either before or after they visited the owner's website. This information may provide other users with an indication of other websites that may be interesting to them based on other members that share a common interest in the owner's website. In other words, if the owner has a website about tractors, the widget embedded into his website may indicate where other members, who are interested in tractors, have navigated to.

In another embodiment, when a website owner defines and embeds a widget into their website, the owner may choose whether an indicator of himself is displayed in the widget. In other words, the website owner's browsing actions may effect the websites indicated in by the widget. In opposite, the website owner may choose to not have an indication of himself to be included in the widget. Hence, the website owner's browsing action would not affect the websites indicated by the widget. In one embodiment, this functionality may be implemented during creation of the widget.

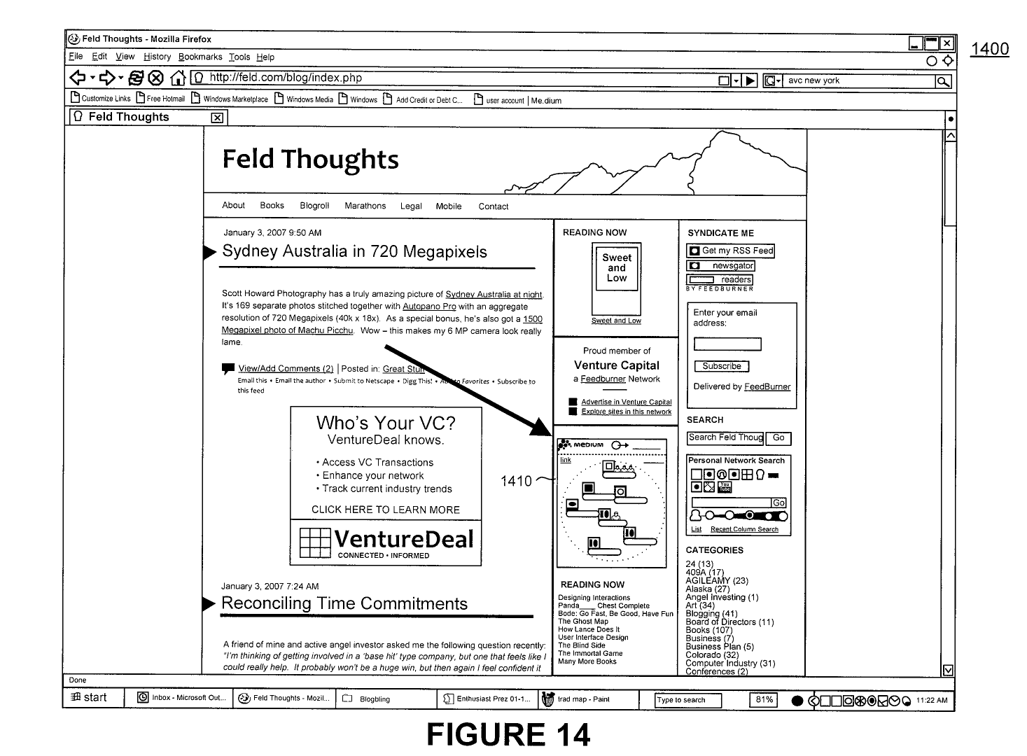

FIG. 14 is a screenshot of a web page illustrating a community widget embedded into a web page. Web page 1400 may be a home page or deeper level page of an owner's website. Based on the steps illustrated in FIG. 13, community widget 1410 may be seen. The physical location of the community widget 1410 may be changed based on the underlying code used to generate the web page 1400. As stated above, there are varying types of community widgets that may exist. A first type is the map widget. A map widget may be considered website-centric. In other words, the widget is placed on a specific page within a website such that the URL of the page becomes the center or focal point of the widget's visual display. Other icons or indicators displayed in the widget represent additional web pages or websites where community members have visited while also having visited the URL where the widget is embedded. In one embodiment, the additional websites visited by other community members are based on the browsing history of each member after they visited the focal point URL. In other words, the browsing history captured before each member visited the focal point URL is irrelevant to the additional websites displayed in the widget. For example, if a map widget is placed on www.mywidgetpage.com/index.html, the focal point of the widget would be the same. Other resources displayed by the widget include other websites where community members have visited after they visited www.mywidgetpage.com. If community members who visit www.mywidgetpage.com also visit www.cnn.com, than an iconic representation of www.cnn.com may appear on the widget. Further, any community member, who have previously visited the focal point URL, who are currently browsing on www.cnn.com will be displayed in the widget. Over time, if community members stop visiting www.cnn.com, the iconic representing www.cnn.com may disappear and be replaced by a web page that is visited more often.

In another embodiment, the prior captured browsing history of each community member may be relevant to the additional websites displayed in the widget. For example, if a map widget is placed on www.mywidgetpage.com/index.html, the focal point of the widget would be the same. Other resources displayed by the widget include other websites where community members have visited before visiting www.mywidgetpage.com.

The second type of community widget is the neighborhood widget. Such a widget type may be content-centric as opposed to website-centric like the map widget described above. A neighborhood widget may be based on one or more types of media content such as sports, music, news, politics, entertainment, games, etc. The number of media content types may be unlimited. In one example a neighborhood widget may be based on content associated with sports. As with other types of community widgets, the neighborhood widget may be placed anywhere within a website. In contrast to the map widget, the neighborhood widget visually displays websites relating to sports.

In one embodiment, the community may pre-determine which websites are associated with each neighborhood widget type. The pre-determined list of websites may be known as “seeds”. The seeds may be stored in a data storage system such as a relational database or other system known by those skilled in the art. The seeds may be manually or automatically changed at any time or under any condition. Once the seeds for a given media content widget have been established, the widget's visual display begins by showing the seeds.

In one embodiment, the value of each seed is temporarily maintained by altering the web browsing history of each member who visits the web page hosting the neighborhood widget. A web browsing history, also known as a tail, may be a listing of the previously visited web pages by the member. A member's tail dynamically changes as the member views differing web pages. The length of the tail may vary. For example, a tail my include the last 30 web pages viewed by the member. As stated above, the value of each seed may be temporarily maintained by deleting the tail of a member who visits the web page hosting the widget. The member's tail may then be replaced with the websites represented by the seeds. In other words, even though the member may not have visited the websites represented by the seeds, the member's tail is altered to that effect. As the member visits additional web pages (including both the seeds and other sites) their tail will dynamically change, thus potentially changing the websites visually displayed in the neighborhood widget.

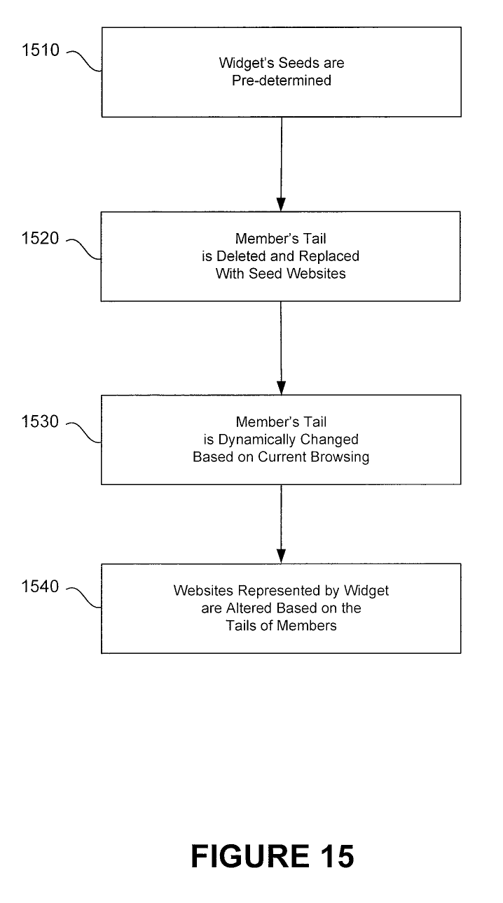

FIG. 15 is a flow diagram illustrating how a neighborhood widget's content may change over time. First, a neighborhood widget is associated with pre-defined websites known as the “seeds” (step 1510). The seeds associated with the neighborhood widget are stored in a data storage system such as a relational database, spread sheet, text file or the like. Once a community member visits a web page hosting the neighborhood widget, the member's tail is deleted and replaced with the URLs representing the seeds of the neighborhood widget (step 1520). This approach temporarily maintains the pre-determined websites that were associated with the neighborhood widget. While the community member browses additional websites and web pages, the member's tail changed to reflect the new browsing history of the member (step 1530). The member's tail as well as other member's who have recently visited the web page hosting the neighborhood widget begin to alter the websites visually represented by the neighborhood widget (step 1540). In one embodiment, if no members visit the web pages represented by the seeds, the neighborhood widget's visual display may eventually discard all the original seed websites and replace them with more relevant websites based on the content visited by community members. In the opposite, if the community members continue to visit the seed websites as well as other websites, a combination of the seed websites and the other websites may eventually be reflected in the neighborhood widget's visual display.

In another embodiment, the frequency and/or timeframe between website visits captured by a user's tail may be used in determining which websites to indicate in the widget's display. In other words, a user's tail may show that website A was visited many times over a short period of time (e.g., one day) and then not visited again. Such information may give little weight to website A. However, if the user's tail shows that website B was visited only twice per day yet visited every day, such information may give more weight to website A.

A third community widget type is a custom view widget. A custom view widget may be customized by the website owner wishing to embed a widget into their website. A custom view widget may be a combination of both map widgets and neighborhood widgets. In other words, a custom view widget may include website-centric representations, content-centric representations as well as other representations deemed by the website owner. For example, a website owner may choose to create a widget that is based on one or more websites explicitly selected by the owner. These websites may or may not be related in any way. The website owner may happen to choose websites based on their personal desires with no obvious relation to content types. Such a custom view widget may also be customized to not alter the websites represented by the widget no matter how much member activity occurs at the websites.

In another embodiment, a website owner may choose to anchor certain websites to the widget. In other words, the browsing history of community members will not effect the presence of the anchored websites. In another embodiment, the website owner may further define a list of websites that are permissible in replacing the anchored websites. For example, the website owner may choose to allow any websites shown in the custom view widget to be replaced if the replacement websites include: www.shotgunnews.com, www.4×4trucks.com or www.fishingboats.com. On the other hand, the website owner may further customize the widget to prevent changes of the representative websites if the changes include, www.bigyachts.com, www.2×4trucks.com or www.archerylovers.com.

Additional forms of customization may include weighting factors placed on both websites and members. For example, friends of the website owner (as described above) may have a higher weighting than non-friend members. In other words, the websites visited by friends are more likely to change the custom view widget's representations than non-friends. Further, different websites may be given a weighting value as well. For example, www.4×4trucks.com may be given a weighting value of 8 and www.2×4trucks.com may be given a weighting value of 4. Therefore members would have to visit www.2×4trucks.com twice as often as www.4×4trucks.com to have the same level of influence on the custom view widget's representations.

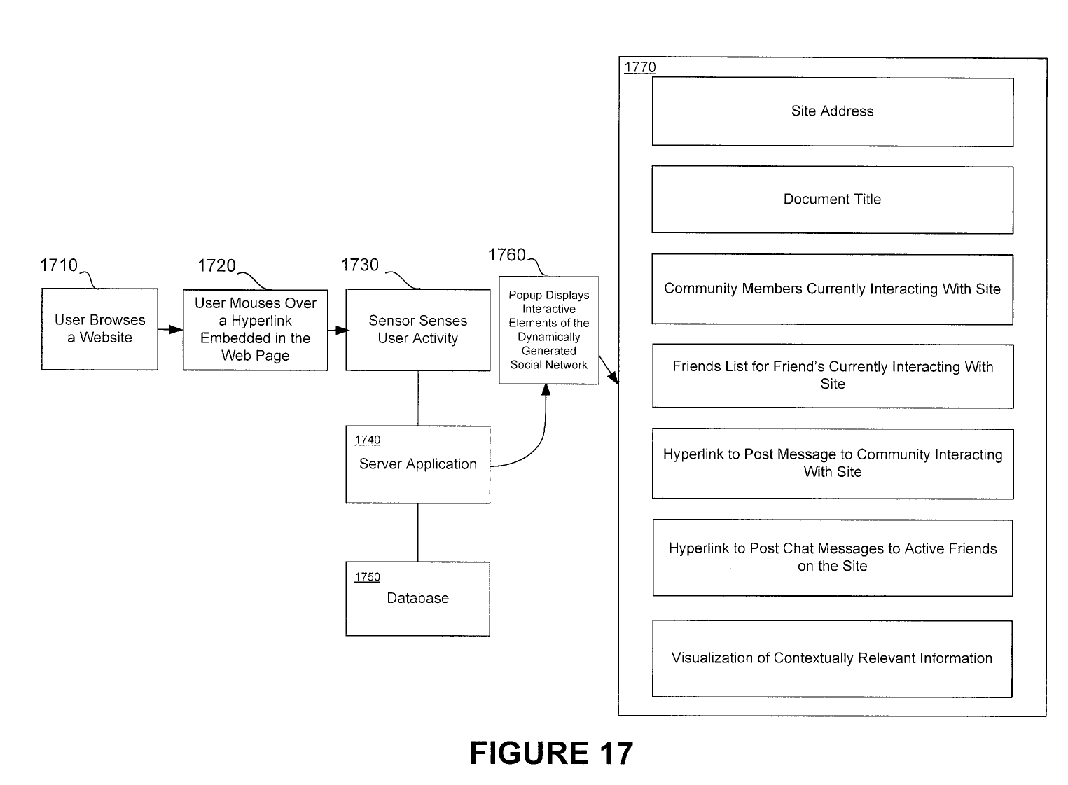

The fourth type of community widget is the inline view widget. While, the other types of widgets are embedded into specific locations on a web page, inline view widgets may be embedded into a hyperlink on a web page. Hence, a user browsing a specific web page may move their mouse cursor over (“move over”) a hyperlink with an embedded inline view widget. This may trigger a pop-up windows to appear representing the corresponding widget. FIG. 17 is a flow diagram illustrating the steps for displaying a pop-up window representing an inline view widget. As a user browses a website (step 1710), they may navigate to a web page containing a hyperlink with an embedded widget. When the user moves over the hyperlink (step 1720), the sensor 157 of the plug-in software 154 senses the activity (step 1730) and communicates the activity to an application server 130 associated with the inline view widget (step 1740). The application server 130 retrieves information about the inline view widget from a database 115 (step 1750) and provides the information associated with the inline view widget to the web page where the hyperlink resides. Next, the content represented by the inline view widget appears in a pop-up window (step 1760). In one embodiment, the content 1770 contained in the pop-up window may include:
the URL of the underlying web page;
the title of the underlying web page;
the first couple of lines of content of the underlying web page;
the number of other members browsing the underlying page;
the names of members visiting the underlying page who are friends of the user;
the names of members visiting the underlying page who are non-friend members;
a hyperlink to post chat messages to other members interacting with the web page associated with the hyperlink;
a hyperlink to post chat messages to friends who are currently interacting with the web page associated with the hyperlink; and
a visualization of contextual relevant information.

In another embodiment, the content of the inline view widget may be equivalent to a map widget but based on the underlying web page associated with the hyperlink, and not the current web page for which the user is viewing. For example, a user may be viewing www.foxnews.com/index.html. Embedded in this page may be a hyperlink pointing to www.thedrudgereport/presidentialrace_{—}2008.html. This hyperlink may have an inline view widget embedded into it. The content represented by the widget is based on the equivalent of a map widget embedded in www.thedrudgereport/presidentialrace_{—}2008.html and not www.foxnews.com/index.html. Hence, when the user, who is visiting www.foxnews.com/index.html, moves over the hyperlink, a widget representing a website-centric view of www.thedrudgereport/presidentialrace_{—}2008.html is displayed. Such a feature permits a user to view the underlying widget without having to navigate to the specific page associated with the hyperlink.

In another embodiment, an inline view widget embedded into a hyperlink may point to either a neighborhood widget or a custom view widget associated with the underlying web page of the hyperlink. In another embodiment, custom third-party widgets may be created, permitting a website owner to embed an inline view widget into a hyperlink which points to a third party widget associated with the underlying web page associated with the hyperlink. The contents and functionality of such third party widgets are beyond the scope of this invention.

In one embodiment, a website owner may create and place as many inline view widgets on their website as they choose. For example, a website owner may create and embed an inline view widget for every hyperlink on their website. In another embodiment, a web page may include both inline view widgets, map widgets, neighborhood widgets, custom view widgets and any combination thereof.

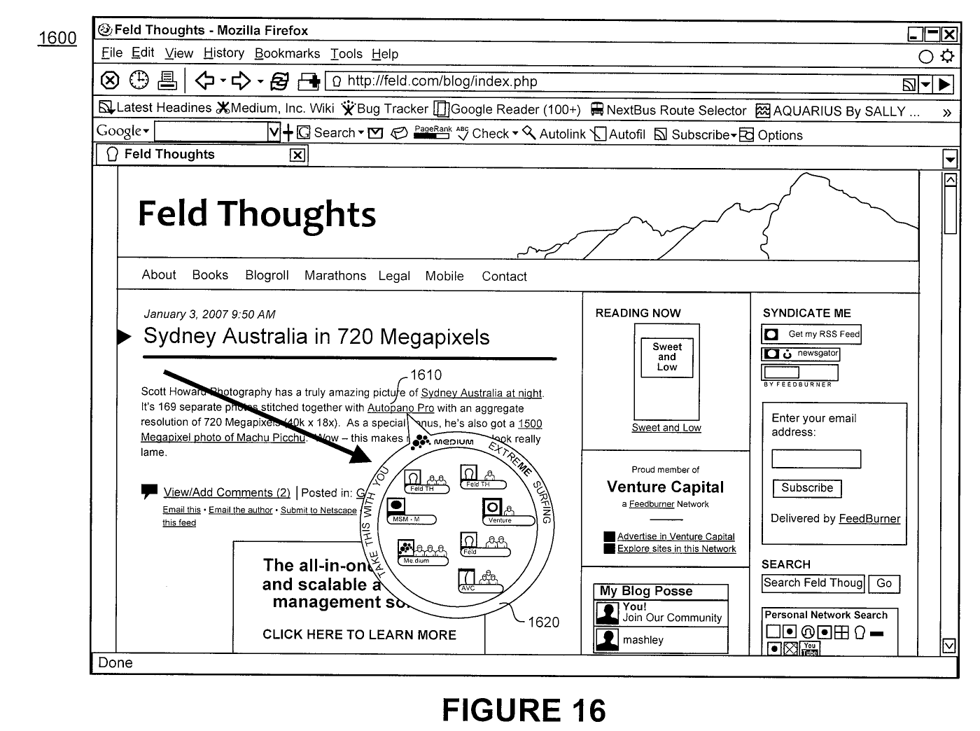

FIG. 16 is a screenshot of a web page illustrating an inline view widget embedded into a hyperlink on a web page. Web page 1600 comprises many hyperlinks to other locations. The hyperlink entitled, “Autopano Pro” 1610 is embedded with a software code to create and display inline view widget 1620 when a user moves over the hyperlink. The user may further click on the hyperlink 1610 to be transported to the underlying web page (not shown) associated with the hyperlink 1610. In one embodiment, the underlying web page may also include a map widget representing the same content as the inline view widget as embedded in the hyperlink 1610. As described in FIG. 16, a pop-up window is displayed when the user moves over a hyperlink with an embedded inline view widget. The pop-up window is oriented to the hyperlink that the mouse is hovering over.

### Contextual Community Enabled Search

It is desirable to facilitate the locating of people, content and communication within a dynamically generated contextual community. The ability to search within the community network may improve a member's opportunity to find relevant content and interact with it. A search function may be provided through a user interface permitting the member to enter key words or natural language phrases to initiate a search.

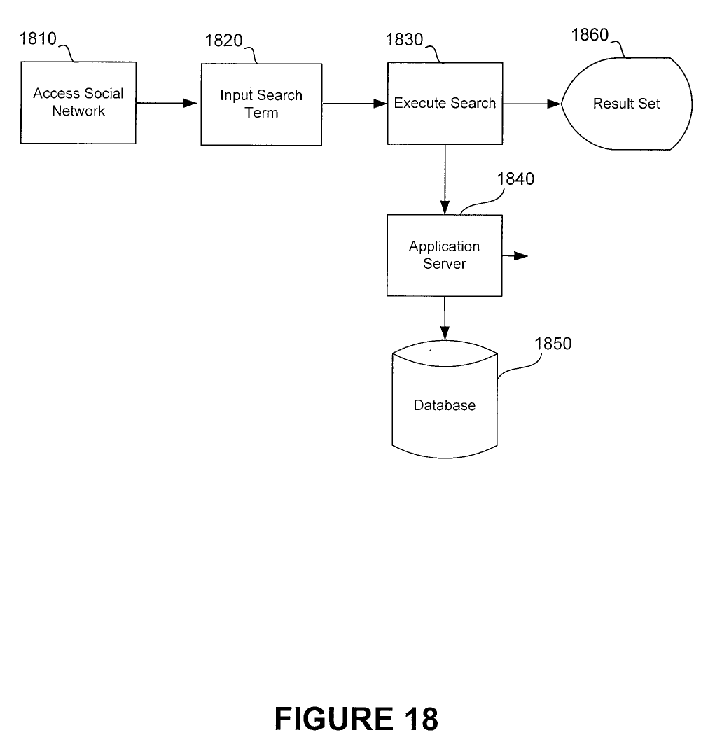

FIG. 18 is a flow diagram illustrating the steps to initiate a search within the community. A community member may begin by accessing the community (step 1810). In one embodiment, the member begins accessing the community by enabling the plug-in 154 associated with their browser. Next, the member may input one or more search terms (step 1820). For example, the search terms entered may be “Brad Feld.” Once the search terms have been input, the search executes (step 1830) by passing the search string to an application server associated with the community (step 1840). The application server then queries the database 115 associated with the community (step 1850). The types of information that may be queried from the database 115 may include: URL's associated with the search terms, community members associated with the search terms, chat messages associated with the search terms and others. Once results from the query are received, the results are returned to the member (step 1860).

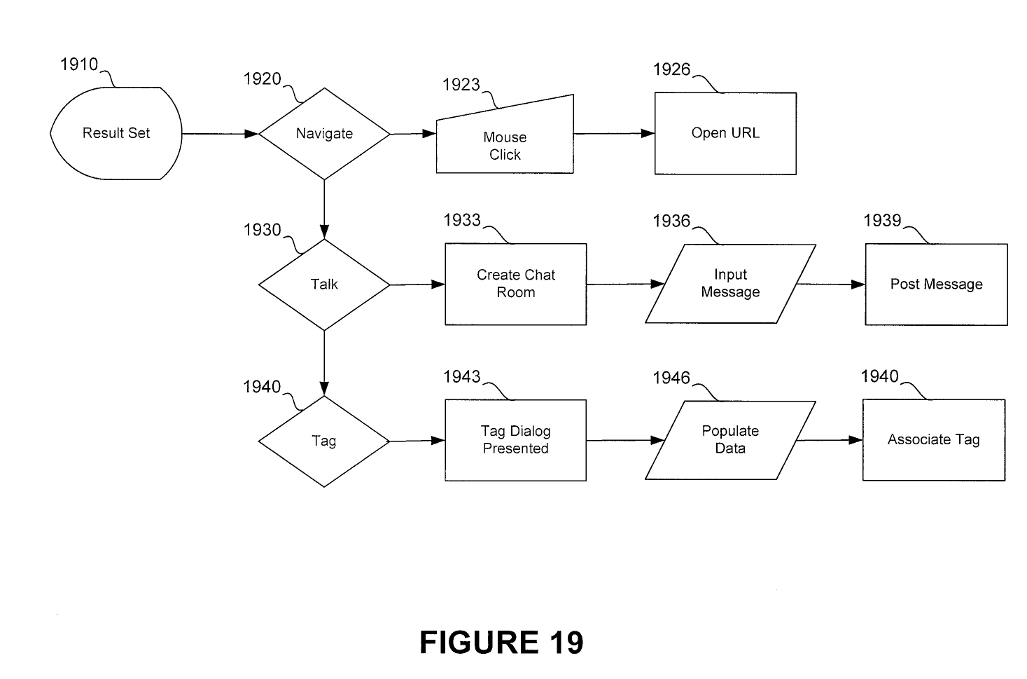

FIG. 19 is a flow diagram illustrating the steps that can be taken when a result set is returned to a member. Once a member receives a result set based on their search query, the member may have multiple options for interacting with the result set (step 1910). First, the member may navigate to one or more of the items in the result set (step 1920). Navigating to one of the result set items may be accomplished through a mouse click (step 1923). Once the mouse click is performed, the URL associated with the result set item is displayed (step 1926). In a differing scenario, the member may wish to interact with a result set item by invoking a chat-based environment (step 1930). First, a chat room may be created (step 1933) which is associated with the result set item. Once the chat room is created the member may input a chat message (step 1936). Further, other members may respond by posting additional chat messages (step 1939). A third scenario, the member may tag the result set item (step 1940). Once tagged, the member may present tag dialog to be associated with the result set item (step 1943). Further, data may be populated (step 1946) within the tag. Lastly, the tag may be associated with one or more resources (step 1949) that may be useful to other members of the community.

### Contextually-Relevant Advertising Generated by Member Actions

It is desirable for members within a dynamically-generated contextual community to receive contextually relevant advertising based on the member's current task or behavior. By analyzing member behaviors, the online community may make recommendations to the member for relevant Internet resources based on the member's current activity. This capability within an online community network may enhance the ability of the community to deliver contextually relevant advertising.

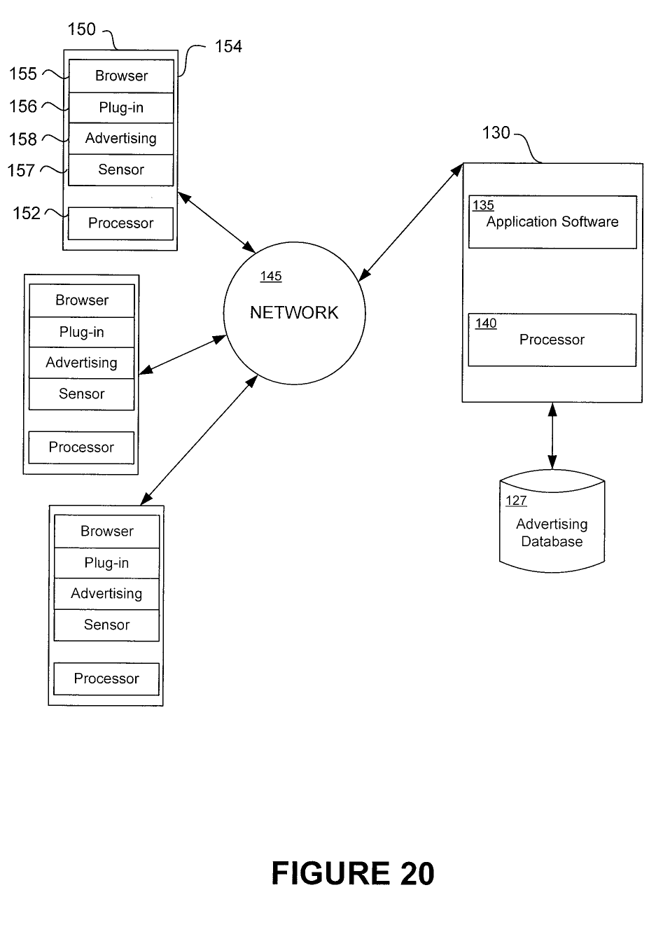

FIG. 20 illustrates one embodiment of an architecture on which the present invention may be utilized. The architecture as illustrated in FIG. 20 may have many similar components as were illustrated in FIG. 2. For example, the present architecture includes an application server 130 comprising application software 135 and a processor 140 for executing the application software 135. Further, the application server 130 is connected, through a network 145, to three actors 150. Each actor 150 operates a computing device that includes a processor 152 executing software 154. This software may include a browser 155, a plug-in 156 for extracting information about the actor's actions and sending it to the application software 135 and a sensor 157 for monitoring the actor's actions. In addition to these components, the software 154 may further include an advertising component 158. The advertising component 158 may pass information to the advertising database 127. Such information may then be utilized by the application server 130 to recommend contextually relevant advertising websites to the actor. In one embodiment, the advertising component 158 may be updated by the application server 130 each time the actor switches tasks within the online community. Additionally, the advertising component 158 may be updated based on a specific time interval across which the actor spends browsing a similar content type.

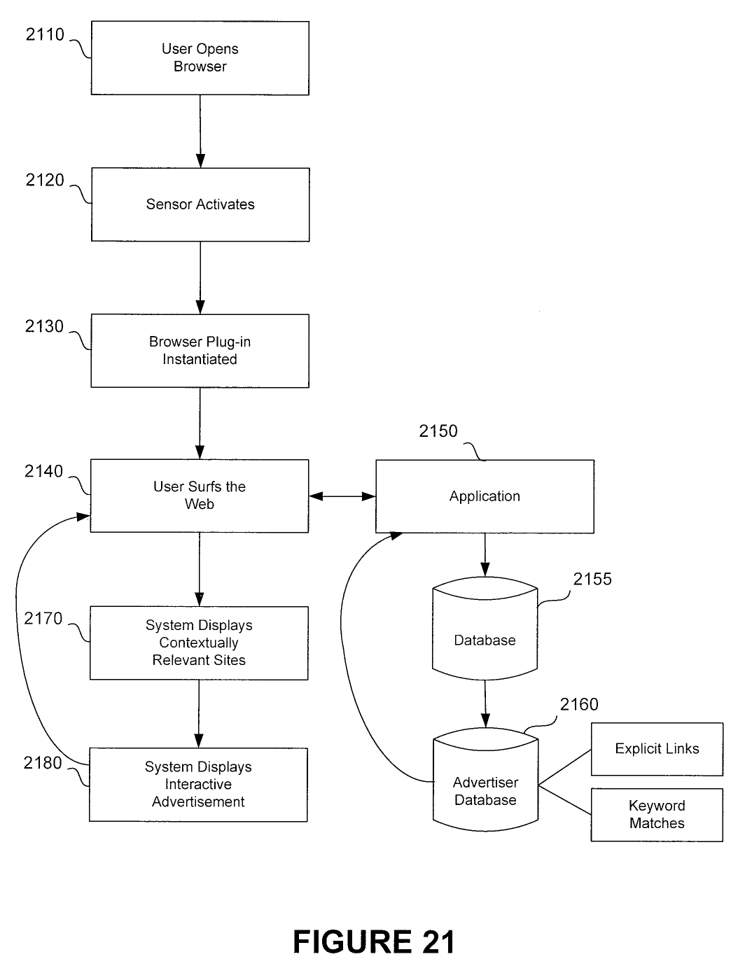

FIG. 21 is a flow diagram illustrating the steps for recommending contextually relevant advertising to a community member. When a community member opens a web browser (step 2110) the sensor 157 which monitors the member's browsing activity is activated (step 2120). Further, the browser plug-in is instantiated (e.g., an instance of the plug-in object is created) (step 2130). As the member surfs the Internet (step 2140), their actions are transmitted to the application server 130 (step 2150) and stored in the database 115 (step 2155).

An advertising database 127 is also queried by an ad engine (not shown) based on the differing keywords and explicit links found on the web pages the member is browsing (step 2160). An ad engine (not shown) is able to detect task-based relevant recommendations by examining explicit links in the database and keyword matches for relevant pages returned by the recommendation engine's algorithm. Explicit links are those Internet resources for which the advertiser has explicitly bound their advertisement. For example, a luxury car dealership in Boulder, Colo. may pay to have their website explicitly bound to other luxury car makers' websites that represent select dealer pages for that geographic locale. When one of those addresses is recommended to the member, they will receive the contextually relevant advertisement for the luxury car dealership in Boulder.

Furthermore, it is possible for the member to interact with an advertisement once it has been provided to the member within the context of the dynamically-generated contextual community. For example, the member may initiate a multi-member chat from an advertisement for a luxury car dealership in Boulder, Colo. This allows the member to post a message, in near real-time, asking about the reputation of that car dealership and leave the multi-member chat posting for others to see and respond to as they enter that context of the community based on their own related task around luxury cars.

Returning back to FIG. 21, the advertising information can then be used by the application server 130 to display contextual relevant websites to the member (step 2170) as well as displaying interactive advertisements to the member (step 2180). As the member continues to browse to different web pages, steps 2150-2180 repeat.

In conclusion, embodiments of the present invention provide, among other things, a system and method for generating recommendations based on an actor's actions. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for showing a user that navigates to a first website a collection of other websites that relate to the first website, comprising the steps of:
identifying a first user having navigated to the first website;
identifying a second user having navigated to the first website;
identifying a third user having navigated to the first website;
collecting a first navigation history tail from the first user, the first navigation history tail identifying websites navigated to by the first user, the first navigation history tail further having an identification of the first user;
collecting a second navigation history tail from the second user, the second navigation history tail identifying websites navigated to by the second user, the second navigation history tail further having an identification of the second user;
collecting a third navigation history tail from the third user, the third navigation history tail identifying websites navigated to by the third user, the third navigation history tail further having an identification of the third user;
combining the first navigation history tail with the second navigation history tail to form a first cumulative navigation history tail;
combining the third navigation history tail with the first cumulative navigation history tail to form a second cumulative navigation history tail;
generating a rank of some of the websites identified in the second cumulative navigation history tail, the rank indicating a popularity factor of some of the websites identified in the second cumulative navigation history tail; and
providing the rank to an applet at the first website so the applet can generate an indication of websites based on the rank.

2. The method of claim 1 further comprising the steps of:
determining a current web navigation location of the first user, the current web navigation location of the first user corresponding to a newest entry in the first navigation history tail;
determining a current web navigation location of the second user, the current web navigation location of the second user corresponding to a newest entry in the second navigation history tail;
determining a current web navigation location of the third user, the current web navigation location of the third user corresponding to a newest entry in the third navigation history tail; and
providing the current web navigation location for each of the first, second and third users to the applet so the applet can generate an indication of the current location of the first, second and third users.

3. The method of claim 2 further comprising the steps of:
providing the identification of the first, second and third users to the applet so the applet can generate the identification of the first, second and third users.

4. The method of claim 3 further comprising the steps of:
collecting an updated first navigation history tail from the first user;
combining the updated first navigation history tail with the second cumulative navigation history tail to form a third cumulative navigation history tail;
regenerating the rank of some of the websites in the third cumulative navigation history tail;
providing the rank to the applet so the applet can regenerate the indicators of websites based on the rank;
determining an updated location of the first user; and
providing the updated location of the first user to the applet so the applet can indicate the updated location of the first user.

5. The method of claim 3 further comprising the steps of:
identifying a fourth user having navigated to the first website;
collecting a fourth navigation history tail from the fourth user, the fourth navigation history tail identifying websites navigated to by the fourth user, the fourth navigation history tail further having an identification of the fourth user;
combining the fourth navigation history tail with the third cumulative navigation history tail to form the fourth cumulative navigation history tail;
regenerating the rank of some of the websites in the fourth cumulative navigation history tail;
providing the rank to the applet so the applet can regenerate the indication of websites based on the rank;
determining a current web navigation location of the fourth user, the current web navigation location of the fourth user corresponding to a newest entry in the fourth navigation history tail;
providing the current web navigation location of the fourth user to the applet so the applet can generate an indication of the current location of the fourth user; and
providing the identification of the fourth user to the applet so the applet can generate the identification of the fourth user.

6. The method of claim 5 further comprising the steps of:
at a pre-defined time interval, collecting an updated third navigation history tail from the third user;
combining the updated third navigation history tail with the fourth cumulative navigation history tail to form the fifth cumulative navigation history tail;
regenerating the rank of some of the web pages in the fifth cumulative navigation history tail;
providing the rank to the applet so the applet can regenerate the indication of websites based on the rank;
determining an updated location of the third user; and
if the updated location of the third user does not correspond to at least one of the websites in the rank, providing instructions to the applet to remove the third user from the indication.

7. The method of claim 1, wherein the first navigation history tail is received from a browser plug-in residing on a computer of the first user.

8. The method of claim 7, wherein the first navigation history tail includes a description of uniform resource locators (“URL”) the first user navigated to over a period of time.

9. The method of claim 8, wherein the period of time began after the first user navigated to the first website.

10. The method of claim 8, wherein the period of time began before the first user navigated to the first website.

11. The method of claim 8, wherein the rank further indicates an ordering of some of the websites based on a cumulative summarization of each of the URLs in the second cumulative navigation history tail that are indicative of some of the websites.

12. The method of claim 1, wherein the applet further generates a permanent indication of the first website.

13. The method of claim 1, wherein a website refers to a URL of a individual web page within the website.

14. The method of claim 1, wherein the applet is configured to indicate, in near real-time, at least one website and at least one user visiting the at least one website.

15. The method of claim 1, wherein the identification of the first user comprises:
a user name; and
a group of public information.

16. The method of claim 15, wherein the identification of the first user further comprises a group of private information undetected by the applet.

17. The method of claim 4, wherein the updated location of the first user corresponds to a newest entry in the updated first navigation history tail.
